(19) United States
(12) Patent Application Publication
(10) Pub. No.: US 2023/0320327 A1
(43) Pub. Date: Oct. 12, 2023

(54) Dual-Purpose Electronic Fence for Pets

(71) Applicant: Bo LI, Ezhou (CN)

(72) Inventor: Bo LI, Ezhou (CN)

(21) Appl. No.: 17/718,361

(22) Filed: Apr. 12, 2022

(51) Int. Cl. A01K 27/00; A01K 15/02

(52) U.S. Cl. CPC A01K 27/009; A01K 15/023

(57) ABSTRACT

The present invention discloses a dual-purpose electronic fence for pets, comprising a host and a receiver. The receiver is fixedly worn on the pet via a binding strap and is connected to the host via a wireless signal; the surface of the host is provided with an electronic fence functional area and a dog training device functional area; and the host has two working modes, namely an electronic fence mode and a dog training mode. The dual-purpose electronic fence for pets provided by the present invention can serve as both an electronic fence for pets and a dog training device. On the one hand, the dual-purpose electronic fence for pets can conveniently and quickly establish a similar area defined by a fence or a rope and ensuring that the pet can freely move, but cannot cross borders through radio signals, and can also warn and punish the pet to force it to stop an improper behavior, thereby achieving the purpose of helping the pet to correct the improper behavior and develop good living habits.

### TECHNICAL FIELD

The present invention relates to electronic supplies for pets, and particularly relates to a dual-purpose electronic fence for pets.

### BACKGROUND

Dogs are people's faithful friends. There is a long history that people raise, train and use dogs. Since ancient times, people and dogs have been living together day and night and have established a deep relationship. Pet dogs are favored because of their petite stature, cute appearance, cleverness, understanding, and loyalty to their owners. It is just because of the above points, dogs have been raised by more and more families as a member of the family. In order to protect the valuables in the home from being damaged by the dog, and to prevent the dog from being lost or having an accident, it is usually necessary to limit the activities of the pet dog within a certain range. There are two main methods of restriction now. According to one method, a rope is used to tie the pet dog, and the other end of the rope is fixedly connected to an object. According to the other method, wood boards or metal meshes are used to build a fence, so that the pet dog cannot run outside the fence. But using a rope is too crude, and building a fence is expensive.

In order to solve the above shortcomings, people also have developed electronic fences for pets. The electronic fence for pets is mainly composed of a fixedly mounted host and a receiving end worn on the pet dog. It mainly sends out electronic signals through the host to generate an invisible and effective electronic fence for the pet dog. When the pet dog goes beyond the range of the electronic fence, the receiving end will prompt the pet dog to come back into the range of the electronic fence as soon as possible, thereby achieving the same effect as the rope or the fence.

At the same time, it is a long-term and continuous process to let pets, especially pet dogs, develop good living habits. In order to supervise and help pet dogs to stop their improper behaviors, it is necessary to use dog training devices to implement some warnings and punishments.

Existing electronic fences and dog training devices are two different electronic supplies for pets, and there is no electronic device that can integrate the two functions together.

### SUMMARY

The purpose of the present invention is to provide a dual-purpose electronic fence for pets. The electronic fence for pets can also be used as a dog training device when necessary.

According to one aspect of the present invention, a dual-purpose electronic fence for pets is provided, and comprises a host and a receiver.

Where, the receiver is fixedly worn on the pet via a binding strap and is connected to the host via a wireless signal.

The surface of the host is provided with an electronic fence functional area and a dog training device functional area, and correspondingly, the host has two working modes, namely an electronic fence mode and a dog training mode.

(I) In case of working in the electronic fence mode, the host sends out radio signals continuously or at periodic intervals, by means of the radio signal, the host establishes an area available for the pet to freely move, the receiver receives the radio signal, and judges that the pet wearing the receiver approaches the edge of the area when the presence of the radio signal is detected or when the disappearance of the radio signal is detected, and at this moment, the receiver warns and urges the pet to fall back until it leaves the edge of the area, thereby ensuring that the pet moves freely within the area and cannot cross the boundaries of the area.

(II) In case of working in the dog training mode, the host sends out a command signal after receiving an external input command, and the receiver warns and punishes the pet to force it to stop an improper behavior according to the command signal after receiving the command signal, thereby achieving the purpose of helping the pet to correct the improper behavior and develop good living habits.

Further, the receiver comprises a main control board, and the main control board is connected to at least one of a vibration motor or an ultrasonic generator or an electric shock electrode.

Specifically speaking, when the host works in the electronic fence mode, the receiver warns and urges the pet to fall back until it leaves the edge of the area in at least one of the following manners:
(a) causing the receiver to have vibration that can be perceived by the pet through the vibration motor; or
(b) sending out ultrasonic waves that can be perceived by the pet through the ultrasonic generator; or
(c) or generating a high-voltage micro-current through the electric shock electrode to perform electric shock on the body surface skin of the pet.

Further, in case of working in the dog training mode, the vibration motor or the ultrasonic generator or the electric shock electrode is enabled to work by pressing a dog training control key disposed on the host, so as to warn or punish the pet dog to force it to stop the improper behavior.

In some implementations, the host is provided with a plurality of dog training control keys for respectively controlling the vibration motor or the ultrasonic generator or the electric shock electrode.

Specifically, the dog training control key is disposed in the dog training device functional area, and the electronic fence functional area is further provided with a plurality of electronic fence control keys.

Further, the dog training control keys comprise a vibration dog training control key for controlling the vibration motor, a vibration dog training control key for controlling the ultrasonic generator, and an electric shock dog training control key for controlling the electric shock electrode.

The electronic fence control keys comprise a signal adjusting key for adjusting the transmitting power of the radio signal, and a penalty control key for adjusting the power or duration of the vibration motor or the ultrasonic generator or the electric shock electrode.

In some implementations, the host is provided with a transmitting antenna for transmitting the radio signal, the host sends out the radio signal continuously or at periodic intervals through the transmitting antenna, and through the radio signal, the host establishes the area available for the pet to freely move; and the receiver receives the radio signal and judges that the pet wearing the receiver approaches the edge of the area when disappearance of the radio signal is detected, and at this moment, the receiver warns and urges the pet to fall back until it leaves the edge of the area, thereby ensuring that the pet freely moves within the area and cannot cross the boundaries of the area. The radio signal generated by the host is transmitted into the air without direction through the transmitting antenna. Since the non-directional signal divergence presents point-like emission, signal waves expand outward in a spherical surface, so with the increase of the distance, the signal intensity decreases in the form of a logarithmic function. After receiving the signal, a receiving end analyzes the intensity of the signal. When the pet dog is more than a certain distance away from the host, and the intensity of the signal received by the receiving end is lower than a set threshold for starting warning, a receiving end controller will start the warning function until the pet dog turns back.

In some other implementations, the host is provided with a signal line for transmitting the radio signal, the signal line is laid at the edge of the area available for the pet to freely move, the host sends out the radio signal continuously or at periodic intervals through the signal line, the receiver receives the radio signal and judges that the pet wearing the receiver approaches the edge of the area when presence of the radio signal is detected, and at this moment, the receiver warns and urges the pet to fall back until it leaves the edge of the area, thereby ensuring that the pet freely moves within the area and cannot cross the boundaries of the area. A relatively weak radio signal is generated by the host through the signal line covered with an insulating sheath, and the above-mentioned radio signal can be received when the receiver is close to the signal line. When the intensity of the radio signal is higher than a set threshold for starting warning, a receiving end controller will start the warning function until the pet dog turns back.

In some other embodiments, the surface of the host is further provided with a function switching key, and by pressing the function switching key, the host switches between the two working modes.

The dual-purpose electronic fence for pets provided by the present invention can serve as both an electronic fence for pets and a dog training device. On the one hand, the dual-purpose electronic fence for pets can conveniently and quickly establish a similar area defined by a fence or a rope and ensuring that the pet can freely move, but cannot cross borders through the radio signal, and can also warn and punish the pet to force it to stop the improper behavior, thereby achieving the purpose of helping the pet to correct the improper behavior and develop good living habits.

### BRIEF DESCRIPTION OF FIGURES

FIG. 1 is a schematic structural diagram of a dual-purpose electronic fence for pets according to an implementation of the present invention.

FIG. 2 is a schematic circuit diagram of a host shown in FIG. 1.

FIG. 3 is an assembly diagram of a receiver shown in FIG. 1.

FIG. 4 is a schematic circuit diagram of the receiver shown in FIG. 3.

FIG. 5 is a schematic structural diagram of a host of a dual-purpose electronic fence for pets according to another implementation of the present invention.

### DETAILED DESCRIPTION

The present invention will be further described in detail below in combination with the accompanying drawings.

### Embodiment 1

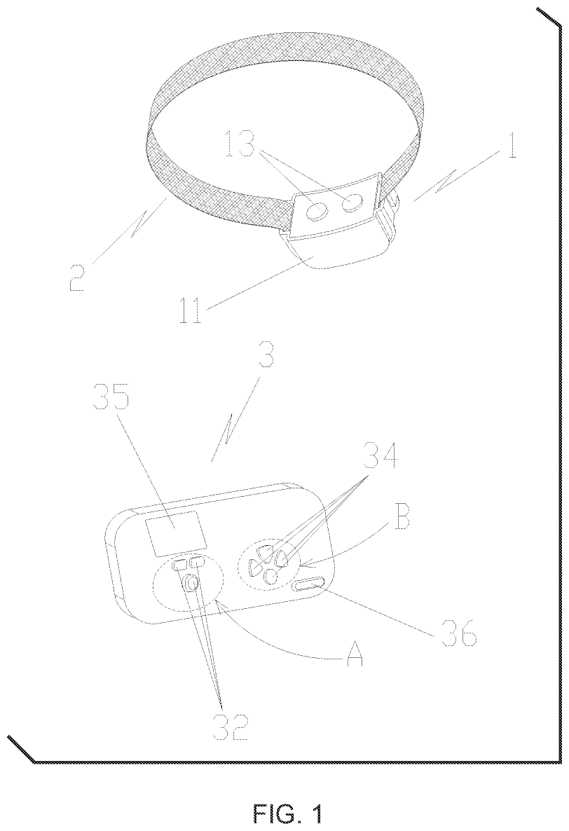

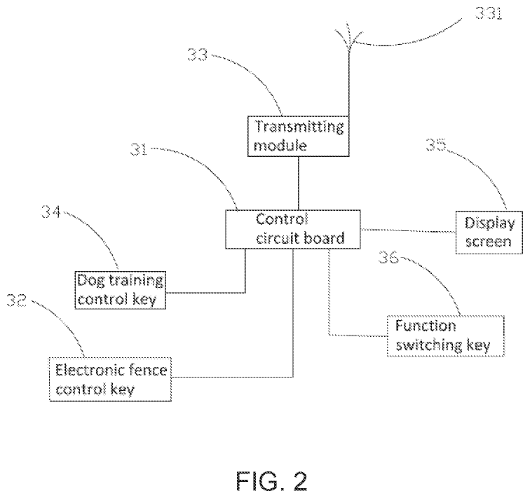

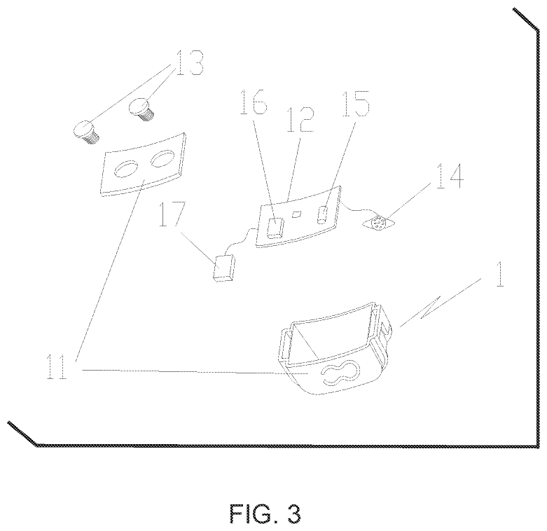

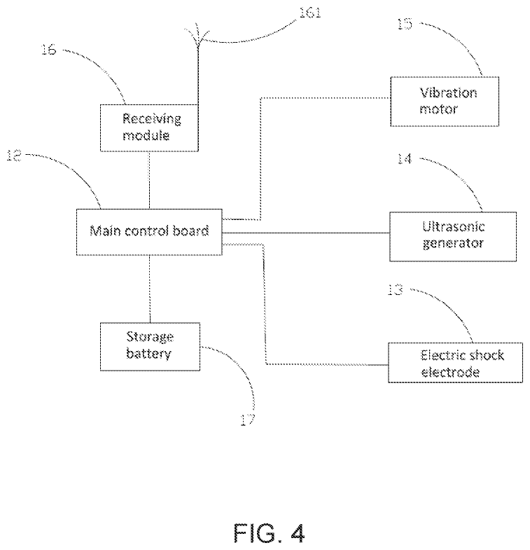

FIG. 1 to FIG. 4 schematically showed a dual-purpose electronic fence for pets according to an implementation of the present invention.

As shown in the figure, the dual-purpose electronic fence for pets comprised a host 3 and a receiver 1.

The receiver 1 was fixedly worn on the pet via a binding strap 2 and was connected to the host 3 via a wireless signal.

The receiver 1 comprised a housing 11 and a main control board 12 disposed inside the housing 11.

The main control board 12 was also connected to a storage battery 17. The storage battery 17 was a dry battery or a rechargeable battery for supplying a working current to the main control board 12.

An electric shock electrode 13 was disposed outside the housing 11, and the electric shock electrode 13 was close to the skin of the pet. The electric shock electrode 13 was connected to the main control board 12 and received a command from the main control board 14.

In this embodiment, a vibration motor 15 and an ultrasonic generator 14 were further disposed inside the housing 11. The vibration motor 15 and the ultrasonic generator 14 were respectively connected to the main control board 12 and received the command from the main control board 12.

The surface of the host 3 was provided with an electronic fence functional area A and a dog training device functional area B. Correspondingly, the host 3 had two working modes, namely an electronic fence mode and a dog training mode.

A plurality of electronic fence control keys 32 were disposed in the electronic fence functional area A.

A plurality of dog training control keys 34 for controlling the vibration motor 15 or the ultrasonic generator 14 or the electric shock electrode 13, respectively, were disposed in the dog training device function area B.

The electronic fence control keys 32 comprised a signal adjusting key for adjusting the transmitting power of a radio signal of the host 3, and a penalty control key for adjusting the power or duration of the vibration motor 15 or the ultrasonic generator 14 or the electric shock electrode 15.

In this embodiment, the dog training control keys 34 comprised a vibration dog training control key for controlling the vibration motor 15, a vibration dog training control key for controlling the ultrasonic generator 14, an electric shock dog training control key for controlling the electric shock electrode 13, and the like.

As shown in the figure, the host 3 was further provided with a control circuit board 31, a transmitting module 33 and a display screen 35.

The electronic fence control key 32, the transmitting module 33, the dog training control key 34 and the display screen 35 were respectively connected to the control circuit board 31.

The host 3 was provided with a transmitting antenna 331 for transmitting the radio signal. The transmitting antenna 331 was connected to the transmitting module 33.

In this embodiment, the main control board 12 was also connected to a receiving module 16 for receiving signals from the transmitting module 33. The receiving module 16 had a receiving antenna 161 and was matched with the transmitting module 33.

(I) In case of working in the electronic fence mode, the host 3 sent out the radio signals continuously or at periodic intervals through the transmitting antenna 331. By means of the radio signal, the host 3 established an area available for the pet to freely move.

The radio signal generated by the host 3 was transmitted into the air without direction through the transmitting antenna 331. Since the non-directional signal divergence presented point-like emission, signal waves expanded outward in a spherical surface, so with the increase of the distance, the signal intensity decreased in the form of a logarithmic function. After receiving the signal through instant messaging 161, a receiving end 3 analyzed the intensity of the signal. When the pet dog was more than a certain distance away from the host 3, and the intensity of the signal received by the receiving end 1 was lower than a set threshold for starting warning, it was judged that the pet wearing the receiver 1 approached the edge of the area, and at this moment, the receiver 1 warned and urged the pet to fall back until it left the edge of the area, thereby ensuring that the pet moved freely within the area and could not cross the boundaries of the area.

(II) In case of working in the dog training mode, the host 3 sent out a command signal after receiving an external input command, and the receiver 1 warned and punished the pet to force it to stop an improper behavior according to the command signal after receiving the command signal, thereby achieving the purpose of helping the pet to correct the improper behavior and develop good living habits.

In this embodiment, when the host 3 worked in the electronic fence mode, the receiver 1 warned and urged the pet to fall back until it left the edge of the area in at least one of the following manners:
(a) causing the receiver 1 to have vibration that could be perceived by the pet through the vibration motor 15; or
(b) sending out ultrasonic waves that could be perceived by the pet through the ultrasonic generator 14; or
(c) generating a high-voltage micro-current through the electric shock electrode 13 to perform electric shock on the body surface skin of the pet.

In case of working in the dog training mode, the vibration motor 15 or the ultrasonic generator 14 or the electric shock electrode 13 was enabled to work by pressing the dog training control key 34 disposed on the host 3, so as to warn or punish the pet dog to force it to stop the improper behavior.

In this embodiment, the surface of the host 3 was further provided with a function switching key 36, and by pressing the function switching key 36, the host 3 switched between the two working modes of the electronic fence mode and the dog training mode.

In some other embodiments, it was also possible for the surface of the host 3 not to be provided with a special function switching key 36, and in case of operating the electronic fence control key 32 and the dog training control key 34 in the electronic fence functional area A and the dog training device functional area B, respectively, the receiving end 1 automatically responded to perform the corresponding functions and actions.

The dual-purpose electronic fence for pets provided by the present invention could serve as both an electronic fence for pets and a dog training device. On the one hand, the dual-purpose electronic fence for pets could conveniently and quickly establish a similar area defined by a fence or a rope and ensuring that the pet could freely move, but could not cross borders through the radio signal, and could also warn and punish the pet to force it to stop the improper behavior, thereby achieving the purpose of helping the pet to correct the improper behavior and develop good living habits.

### Embodiment 2

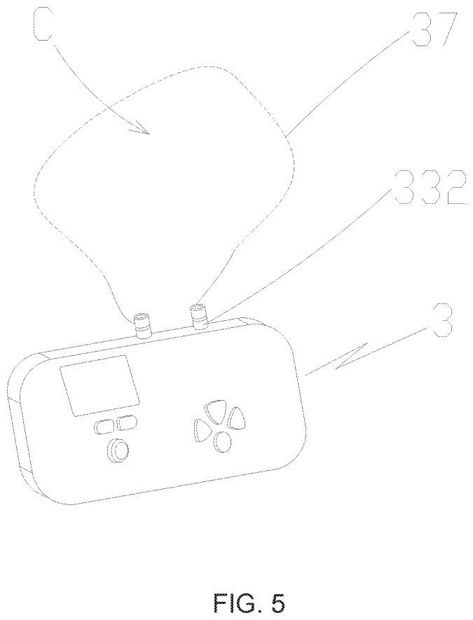

FIG. 5 schematically showed a dual-purpose electronic fence for pets according to an implementation of the present invention.

As shown in the figure, the difference from Embodiment 1 is that the host 3 was provided with a signal line 37 for transmitting radio signals. The signal line 37 was covered with an insulating sheath and detachably connected to a binding post 332 disposed on the host 3. The binding post 332 was connected to a transmitting module in the host 3.

The signal line 37 was laid at the edge of an area C available for the pet to freely move.

The host 3 sent out a relatively weak radio signal continuously or at periodic intervals through the signal line 37. The receiver could receive the above radio signal when being close to the signal line, and judged that the pet wearing the receiver approached the edge of the area C when presence of the radio signal was detected, and at this moment, the receiver warned and urged the pet to fall back until it left the edge of the area, thereby ensuring that the pet freely moved within the area and could not cross the boundaries of the area.

What is described above is merely some implementations of the present invention. For those of ordinary skill in the art, without departing from the inventive concept of the present invention, several modifications and improvements can also be made, which all belong to the protection scope of the present invention.

What is claimed is:

1. A dual-purpose electronic fence for pets, comprising a host and a receiver, wherein:
the receiver is fixedly worn on the pet via a binding strap and is connected to the host via a wireless signal;
the surface of the host is provided with an electronic fence functional area and a dog training device functional area; and the host has two working modes, namely an electronic fence mode and a dog training mode;
in case of working in the electronic fence mode, the host sends out radio signals continuously or at periodic intervals, by means of the radio signal, the host establishes an area available for the pet to freely move, the receiver receives the radio signal, and judges that the pet wearing the receiver approaches the edge of the area when the presence of the radio signal is detected or when the disappearance of the radio signal is detected, and at this moment, the receiver warns and urges the pet to fall back until it leaves the edge of the area, thereby ensuring that the pet moves freely within the area and cannot cross the boundaries of the area; and
in case of working in the dog training mode, the host sends out a command signal after receiving an external input command, and the receiver warns and punishes the pet to force it to stop an improper behavior according to the command signal after receiving the command signal, thereby achieving the purpose of helping the pet to correct the improper behavior and develop good living habits.

2. The dual-purpose electronic fence for pets according to claim 1, wherein the receiver comprises a main control board, and the main control board is connected to at least one of a vibration motor or an ultrasonic generator or an electric shock electrode.

3. The dual-purpose electronic fence for pets according to claim 2, wherein when the host works in the electronic fence mode, the receiver warns and urges the pet to fall back until it leaves the edge of the area in at least one of the following manners:
causing the receiver to have vibration that can perceived by the pet through the vibration motor; or
sending out ultrasonic waves that can be perceived by the pet through the ultrasonic generator; or
generating a high-voltage micro-current through the electric shock electrode to perform electric shock on the body surface skin of the pet.

4. The dual-purpose electronic fence for pets according to claim 2, wherein in case of working in the dog training mode, the vibration motor or the ultrasonic generator or the electric shock electrode is enabled to work by pressing a dog training control key disposed on the host, so as to warn or punish the pet dog to force it to stop the improper behavior.

5. The dual-purpose electronic fence for pets according to claim 2, wherein the host is provided with electric shock dog training control keys for respectively controlling the vibration motor or the ultrasonic generator or the electric shock electrode.

6. The dual-purpose electronic fence for pets according to claim 5, wherein the dog training control key is disposed in the dog training device functional area, and the electronic fence functional area is further provided with a plurality of electronic fence control keys.

7. The dual-purpose electronic fence for pets according to claim 6, wherein
the dog training control keys comprise a vibration dog training control key for controlling the vibration motor, a vibration dog training control key for controlling the ultrasonic generator, and a plurality of dog training control keys for controlling the electric shock electrode; and
the electronic fence control keys comprise a signal adjusting key for adjusting the transmitting power of the radio signal, and a penalty control key for adjusting the power or duration of the vibration motor or the ultrasonic generator or the electric shock electrode.

8. The dual-purpose electronic fence for pets according to claim 1, wherein the host is provided with a transmitting antenna for transmitting the radio signal, the host sends out the radio signal continuously or at periodic intervals through the transmitting antenna, and through the radio signal, the host establishes the area available for the pet to freely move; and the receiver receives the radio signal and judges that the pet wearing the receiver approaches the edge of the area when disappearance of the radio signal is detected, and at this moment, the receiver warns and urges the pet to fall hack until it leaves the edge of the area, thereby ensuring that the pet freely moves within the area and cannot cross the boundaries of the area.

9. The dual-purpose electronic fence for pets according to claim 1, wherein the host is provided with a signal line for transmitting the radio signal, the signal line is laid at the edge of the area available for the pet to freely move, the host sends out the radio signal continuously or at periodic intervals through the signal line, the receiver receives the radio signal and judges that the pet wearing the receiver approaches the edge of the area when presence of the radio signal is detected, and at this moment, the receiver warns and urges the pet to fall back until it leaves the edge of the area, thereby ensuring that the pet freely moves within the area and cannot cross the boundaries of the area.

10. The dual-purpose electronic fence for pets according to claim 1, wherein the surface of the host is further provided with a function switching key, and by pressing the function switching key, the host switches between the two working modes.
